(19) United States
(12) Patent Application Publication
(10) Pub. No.: US 2013/0217508 A1
(43) Pub. Date: Aug. 22, 2013

(54) Analysis Of Games Of Chance

(71) Applicant: Glenn GOLDEN, Abita Springs, LA (US)

(72) Inventor: Glenn GOLDEN, Abita Springs, LA (US)

(21) Appl. No.: 13/402,607

(22) Filed: Feb. 22, 2012

(51) Int. Cl. A63F 13/00

(52) U.S. Cl. 463/43

(57) ABSTRACT

A system for analyzing games of chance includes a data analysis device configured to perform analysis of gameplay data and to output a result to a player, where the result is based on a comparison of machine characteristic data and personal characteristic data.

### BACKGROUND

1. Field of the Invention

Embodiments of the present invention relate to games of chance. More particularly, embodiments of the present invention relate to a system for analysis of games of chance.

2. Background

The outcomes of many games of chance are not dependent on past events. For instance, the odds of a coin flip coming up heads is not affected by whether the coin came up heads or tails on a previous flip. Similarly, the outcomes of many casino games, such as slot machines and roulette wheels, for example, are not affected by previous outcomes. The odds of any particular outcome are the same at each play.

Notwithstanding these circumstances, some players at a casino may forego playing a particular slot machine because it has just paid out a large jackpot, or may not place a wager on a particular number because it has just come up on the roulette wheel. These players may consider that because the machine or number was recently a winner, its odds of again being a winner right away are decreased. Some players may seek out to play particular game machines that have recently been paying out frequently, considering these machines to be “hot,” and hoping the payouts will continue. Other players may seek out to play particular game machines that have recently been paying out infrequently, considering these machines to be “cold” and due to pay out soon. Players will often ask casino personnel to be directed to such a hot or cold machine.

### BRIEF SUMMARY

In reality, game machines are not hot or cold. The odds of a particular result remain constant regardless of past outcomes. Machines that may appear hot or cold are simply showing accepted variations in a random distribution that have no relationship to future events. Players who seek out hot or cold machines may not understand this or may ignore it, but the fact remains that players desire to know past performance information of particular game machines. This knowledge can influence the particular machine they choose to play, or whether they choose to play a machine at all. Thus, providing this information to players can increase gameplay in a casino.

What is needed is a system to provide such information to a player in a way that will entice the player to play one or more game machines. The present invention satisfies the above needs and provides further related advantages as will be made apparent by the description of the embodiments that follows.

Some embodiments of the present invention provide a system for analyzing games of chance, including a database configured to receive and store gameplay data, and a gameplay analysis device configured to perform analysis of the gameplay data and to output result data to a player device.

Some embodiments of the present invention provide a method for analyzing games of chance, including receiving gameplay data at a database, storing the gameplay data at the database, accessing the gameplay data by a gameplay analysis device, performing analysis of the gameplay data at the gameplay analysis device, and outputting result data from the gameplay analysis device.

Some embodiments of the present invention provide a computer program product for analyzing games of chance, the product including a computer-usable medium having computer program logic recorded thereon for causing at least one processor to receive gameplay data at a database, store the gameplay data at a database, access the gameplay data by a gameplay analysis device, perform analysis of the gameplay data at the gameplay analysis device, and output result data from the gameplay analysis device.

Additional features of the invention will be set forth in the description that follows, and in part will be apparent from the description, or may be learned by practice of the invention. Both the foregoing general description and the following detailed description are exemplary and explanatory and are intended to provide further explanation of the invention as claimed.

### BRIEF DESCRIPTION OF THE FIGURES

The accompanying figures, which are incorporated herein, form part of the specification and illustrate embodiments of the present invention. Together with the description, the figures further serve to explain the principles of and to enable a person skilled in the relevant arts to make and use the invention. In the drawings, like reference characters indicate identical or functionally similar elements.

FIG. 1 illustrates a diagrammatic view of a game analysis system, according to an embodiment presented herein.

FIG. 2 illustrates a diagrammatic view of data relating to game analysis, according to an embodiment presented herein.

FIG. 3 illustrates a diagrammatic view of a method for analyzing a game, according to an embodiment presented herein.

FIG. 4 illustrates an exemplary game analysis report, according to an embodiment presented herein.

FIG. 5 illustrates an exemplary game analysis report, according to an embodiment presented herein.

FIG. 6 illustrates an exemplary game analysis report, according to an embodiment presented herein.

FIG. 7 illustrates an exemplary game analysis report, according to an embodiment presented herein.

FIG. 8 illustrates an exemplary game analysis report, according to an embodiment presented herein.

FIG. 9 illustrates an exemplary game analysis report, according to an embodiment presented herein.

FIG. 10 illustrates an exemplary game analysis report, according to an embodiment presented herein.

FIG. 11 illustrates an exemplary game analysis report, according to an embodiment presented herein.

FIG. 12 illustrates an exemplary game analysis report, according to an embodiment presented herein.

FIG. 13 illustrates an exemplary game analysis report, according to an embodiment presented herein.

FIG. 14 illustrates an exemplary game analysis report, according to an embodiment presented herein.

FIG. 15 illustrates an exemplary game analysis report, according to an embodiment presented herein.

FIG. 16 illustrates an exemplary game analysis report, according to an embodiment presented herein.

FIG. 17 illustrates an exemplary game analysis report, according to an embodiment presented herein.

FIG. 18 illustrates an exemplary game analysis report, according to an embodiment presented herein.

FIG. 19 illustrates an exemplary game analysis report, according to an embodiment presented herein.

FIG. 20 illustrates an exemplary game analysis report, according to an embodiment presented herein.

FIG. 21 illustrates an exemplary game analysis report, according to an embodiment presented herein.

FIG. 22 illustrates an exemplary game analysis report, according to an embodiment presented herein.

### DETAILED DESCRIPTION OF THE INVENTION

Unless defined otherwise, all technical and scientific terms used herein have the same meaning as commonly understood by one of ordinary skill in the art to which this invention belongs. In case of conflict, the present application including the definitions will control. Also, unless otherwise required by context, singular terms shall include pluralities and plural terms shall include the singular. All publications, patents, and other references mentioned herein are incorporated by reference in their entireties for all purposes.

The term “invention” as used herein is a non-limiting term and is not intended to refer to any single embodiment of the invention but encompasses all possible embodiments.

The following detailed description refers to the accompanying figures, which illustrate embodiments of the present invention. Other embodiments are possible and may fall within the scope of the present invention. Modifications can be made to the embodiments described herein without departing from the spirit and scope of the present invention. Therefore, the following detailed description is not meant to be limiting. The operation and behavior of the embodiments presented are described with the understanding that various modifications and variations of the embodiments may be within the scope of the present invention.

A gaming establishment, such as, for example, a casino, may have a number of game machines, such as, for example, slot machines. Game machine players and the gaming industry at large have various metrics with which to measure the performance of game machines. A typical game machine may receive value from a player, in the form of, for example, credit, cash, or equivalent. In return, the player receives a “play” at the machine. If the play results in a positive outcome (a “win”) for the player, the player may receive value from the machine, in the form of, for example, a prize, credit, cash, or equivalent payout, and the play is completed. If the play results in a negative outcome (a “loss”) for the player, the machine retains the value received from the player, and the play is completed.

Many game machines have a “theoretical hold” (also known as “par”), which indicates the theoretical percentage of amount received that should by design be retained (held) by the machine on average. In reality, the percentage retained at a given time or for a given period may be higher or lower than the theoretical hold. An indication of the relationship of the actual hold to the theoretical hold may be used by a player to determine whether a machine is desirable to play. For instance, a machine operating above its theoretical hold (i.e., holding above par) may be considered a “cold” machine, and a machine operating below its theoretical hold (i.e., holding below par) may be considered a “hot” machine. Some players may prefer to play a hot machine over a cold machine, and other players may prefer to play a cold machine over a hot machine.

Other metrics of a game machine that may be used by players to determine whether a machine is desirable to play include, for example, the amount paid out over a period of time, the jackpot amount paid out over a period of time (a jackpot being a specific type of payout usually associated with a specific outcome of the particular game being played), the jackpot frequency, and jackpot payout as a percentage of total payout.

Some players may also be interested in comparing the performance of different game machines. Any game machine characteristics, including those described herein, can be evaluated and compared, to provide a player an indication of the performance of one or more game machines. Further, a player may be influenced by the relative popularity of machines, and may prefer to play a game machine due to its popularity (or lack thereof) among other players, compared to other game machines. A player may be interested in filtering a comparison among different game machines, for example, by comparing only those machines meeting certain criteria, such as, for example, game type and denomination(s) accepted. In the case where a single game machine offers more than one game type or denomination, the embodiments provided herein may apply to all game types or denominations offered by the machine, and/or may apply individually to each game type and denomination offered by the machine.

If a player does not have access to information about the past performance of game machines, that player may choose not to play a game machine at all, or may play fewer game machines or spend less money at them than the player would if provided with such information. A player with information about the past performance of game machines may develop a strategy based on this information, believed to maximize the player's odds of achieving positive outcomes. A player with such information may decide to play a machine because its past performance is appealing to the player, even if the player otherwise would not have played at all. Thus, even though the past performance of game machines does not affect their future performance, simply providing players with such information may increase play of game machines. Play may be further increased by analyzing such information in view of information about particular players, and presenting the game performance information as a function of a player's personal information. For example, game performance information may be provided in a way highlighting information determined to be most relevant to a particular player, or most likely to entice a particular player to play a game machine.

Providing a player with access to information about the past and current performance and characteristics of game machines, which information may not be available elsewhere, can have a number of further benefits. For example, it can encourage membership in a club, where membership is required for access to the information, and can provide an incentive for a player to provide personal information (e.g., phone number, e-mail address) to a gaming establishment. Also for example, it can give players the illusion that they have an edge. Also for example, it can encourage players to have their play rated and performance tracked. Also for example, it can provide analysis of player selections compared to actual results. Also for example, it can provide a gaming establishment with multiple reasons to contact players (e.g., when conditions are met for suggesting game machines for play by a player, or for social media interaction). Also for example, it can provide inducement for players to return to the gaming establishment.

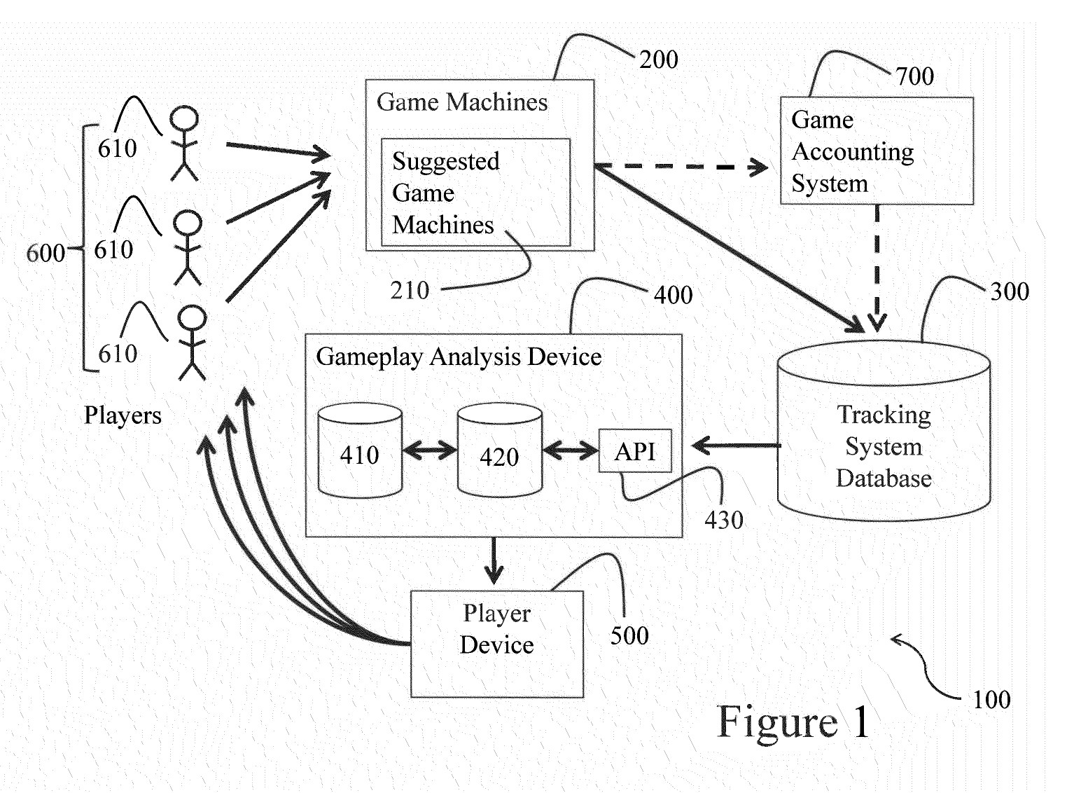

FIG. 1 illustrates a game analysis system 100 according to some embodiments of the present invention. Game analysis system 100 can include game machines 200, a tracking system database 300, a gameplay analysis device 400, and a player device 500. Game analysis system 100 may optionally include a game accounting system 700. Game analysis system 100 can receive input from players 600 through game machines 200.

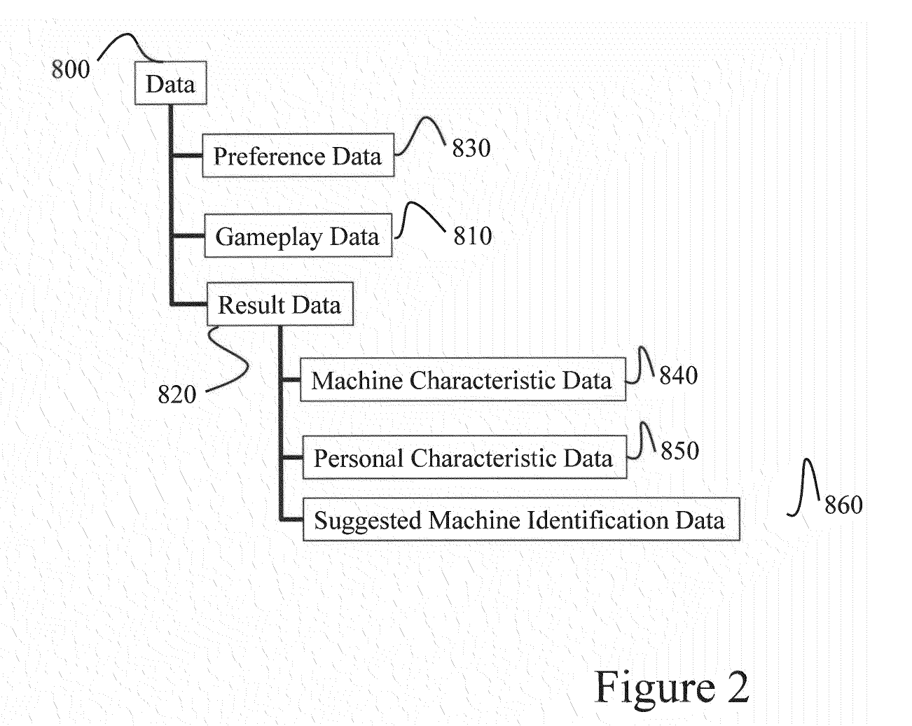

Game analysis system 100 may provide a subject player 610 with information about the past and current performance and characteristics of game machines 200 in a gaming establishment. Each game machine 200 may record and transmit gameplay data 810 including information about each play occurring at that game machine 200. Gameplay data 810 (see FIG. 2) may be received by and stored in tracking system database 300. Gameplay data 810 may be accessed by gameplay analysis device 400. Gameplay analysis device 400 may apply a variety of algorithms to gameplay data 810 to determine result data 820. Result data 820 may be representative of information about the past and current performance and characteristics of game machines 200. Representations of result data 820 can be provided to a subject player 610 via player device 500 (e.g., via a display thereof). In some embodiments subject player 610 can affect the manner of display and content displayed (including representations of result data 820) by manipulating inputs (e.g., a keyboard, buttons, a touchscreen) of player device 500, as would be appreciated by one of skill in the art.

Result data 820 (see FIG. 2) may include, for example, machine characteristic data 840, which may relate to characteristics of one or more game machines 200, and which may be determined by gameplay analysis device 400 through analysis of play by players 600 on such game machines 200. Result data 820 may include, for example, personal characteristic data 850, which may relate to characteristics of one or more game machines 200 played by subject player 610, and which may be determined by gameplay analysis device 400 through analysis of subject player 610's play on such game machines 200. Result data 820 may include, for example, suggested machine identification data 860, which may include, for example, information identifying one or more game machines 200 that have been selected for display to and/or suggested for play by subject player 610.

Players 600 may play game machines 200 over a period of time. Each player 600 can be associated with a player account, which may be provided by a gaming establishment or organization. A player account can simply be an identifier for an associated player, and/or can be associated with value stored with reference to the account. Each player 600 may have access to his or her player account. For example, each player 600 may have an encoded card (e.g., encoded magnetically or including an electronically readable tag, such as a radio-frequency identification tag), may have an account-specific device (temporarily or permanently linked to his or her account) such as player device 500, may have an account number, and/or may access his or her account using paper forms.

Each game machine 200 can offer one or more games to players 600, and each game can have one or more play denominations (i.e., value required to be input to initiate or continue play by a subject player 610). For example, a game machine 200 can offer one or more of slots, poker, blackjack, keno, roulette, and any other game of chance as would be apparent to one of skill in the art. “Game of chance” is used broadly herein and can include any game in which one or more aspects are dependent on chance. To play a game machine 200, subject player 610 can input sufficient value to initiate or continue play. Subject player 610 may input physical currency, or may input value in another way (e.g., from his or her player account). Subject player 610 may input value from his or her player account in a number of ways. For example, subject player 610 may input value from his or her player account by inserting an encoded card linked to his or her account into a corresponding card reader in game machine 200. Also for example, subject player 610 may input value from his or her player account by associating his or her player device 500 with game machine 200 (e.g., by activating a radio-frequency identification (RFID) reader of game machine 200 with an RFID chip in player device 500, or by scanning a quick response (QR) code on the machine with a QR scanner or camera of player device 500). Also for example, subject player 610 may input value from his or her player account by entering his or her account number into a keypad of game machine 200.

Once subject player 610 has input sufficient value to begin play, subject player 610 can play game machine 200. Such play can vary depending on the characteristics of the game and game machine 200 being played. For example, during play, subject player 610 can wager value on features of an unknown event or outcome (these features may be hidden from subject player 610 or as yet undetermined (i.e., to be generated in the future)). For example, in a roulette game, subject player 610 can wager value on what number(s) and/or color a ball will land when spun around a roulette wheel. In practice, the presentation of play may be a computer-generated video depiction of the game (e.g., a ball and roulette wheel), and the outcome (e.g., where the ball appears to land) may be determined by a computer algorithm. In the case where the wager of subject player 610 matches the outcome of play or is otherwise consistent with game rules to result in a payout to subject player 610, subject player 610 receives value from game machine 200. This is considered a positive outcome for subject player 610. In the case where the wager of subject player 610 does not match the outcome of play or is otherwise inconsistent with game rules to result in a payout to subject player 610, subject player 610 receives no value from game machine 200, and game machine 200 retains the value previously input by subject player 610. This is considered a negative outcome for subject player 610.

An individual outcome typically cannot be accurately predicted. Some players 600 may come to believe, however, that their chance of positive outcome(s) may be greater on one game machine 200 than another game machine 200. This belief can be a function of characteristics of the game machines 200, and can be due to a variety of factors. For example, some players 600 may be superstitious, and may find some personal or other significance to machines with particular characteristics. Also for example, some players 600 may believe they have achieved positive outcomes in the past on game machines 200 sharing certain characteristics, and may believe their chances of additional positive outcomes are best on game machines 200 also sharing these characteristics. Also for example, some players 600 may believe they have achieved positive outcomes in the past on game machines 200 sharing certain characteristics, and may believe their chances of additional positive outcomes are best on game machines 200 not sharing these characteristics. Also for example, some players 600 may actually have achieved positive outcomes in the past on game machines 200 sharing certain characteristics (which may be due to accepted variations in a random distribution), and may believe their chances of additional positive outcomes are best on game machines 200 also sharing these characteristics. Also for example, some players 600 may actually have achieved positive outcomes in the past on game machines 200 sharing certain characteristics (which may be due to accepted variations in a random distribution), and may believe their chances of additional positive outcomes are best on game machines 200 not sharing these characteristics. As will be appreciated by one of skill in the art, past negative outcomes can similarly influence the game machine(s) 200 at which some players 600 believe they will have better chances of positive outcome(s).

For instance, some players 600 may believe that their odds of a positive outcome are best at a game machine 200 that has been holding above par for a period (e.g., for the day so far, for the past 6 hours, for the past 24 hours, for yesterday, for the past 7 days, for the 7 days prior to yesterday, for the past 30 days, for the 30 days prior to yesterday, for the past year, for the lifetime of the machine), while some players 600 may believe that their odds of a positive outcome are best at a game machine 200 that has been holding below par for a period. Players 600 may desire information about each game machine 200 in order to determine which game machine(s) 200 most closely matches the game machine(s) 200 at which they believe they have the best chance at positive outcome(s).

Each game machine 200 may record information related to all or a subset of events that occur in association with its play by players 600, and administrative or other events. This information may include, for example, information identifying each of players 600 who played game machine 200, and information relating to each instance of play (e.g., identification of game type, denomination, particular game machine 200 played, outcome, value input, value output). Such information can be recorded throughout the life of game machine 200, and may be referred to as gameplay data 810.

In some embodiments, gameplay data for each game machine 200 is recorded and permanently stored at that game machine 200 (or stored for a period of time). In some embodiments, gameplay data 810 for each game machine 200 is recorded at that game machine 200 and transmitted to tracking system database 300 for storage. Such transmission can occur continuously (i.e., substantially immediately following recording of each event) or can occur periodically (e.g., each minute, each 10 minutes, each hour, each day, each week, each month).

Tracking system database 300 can receive and store data from a variety of sources. In some embodiments, tracking system database 300 can receive and store gameplay data 810 from all or a subset of game machines 200.

In some embodiments, gameplay data 810 is transmitted to game accounting system 700 before, contemporaneously, or after being transmitted to tracking system database 300. In some embodiments, gameplay data 810 is transmitted to tracking system database 300 from game accounting system 700. In some embodiments, game accounting system 700 replaces tracking system database 300 within game analysis system 100. Game accounting system 700 can be an administrative system operated by a gaming establishment to account for operation of all or a subset of game machines 200. Game accounting system 700 can be an audited system used by the gaming establishment and/or gaming regulation agencies to monitor operation of all or a subset of game machines 200.

Gameplay analysis device 400 can access all or a subset of gameplay data 810. In some embodiments, gameplay analysis device 400 can access such gameplay data 810 from tracking system database 300. In some embodiments, gameplay analysis device 400 can access such gameplay data 810 from tracking system database 300 on a read-only basis, and may be separated from tracking system database 300 by a firewall. Gameplay analysis device 400 can perform an analysis of such gameplay data 810, and results of such analysis can be provided to one or more subject players 610.

Gameplay analysis device 400 can identify all or a subset of gameplay data 810 that was generated through the action of or in relation to a particular subject player 610. This data may include, for example, information identifying the particular game machines 200 played by subject player 610; information relating to outcomes obtained by subject player 610 at each game machine 200 played; and information relating to the value won or lost by subject player 610. This data may relate to any period of time for which gameplay data 810 is available.

Gameplay analysis device 400 can identify all or a portion of gameplay data 810 that was generated at a particular game machine 200, without regard for which player 600 is associated with the data. This data may include, for example, information identifying game machine 200, information relating to outcomes by all players 600 at the particular game machine 200, and information relating to the value won or lost by all players 600 at the particular game machine 200.

Gameplay analysis device 400 may operate as a single device, or may operate as multiple devices in communication with each other. For example, in some embodiments, gameplay analysis device 400 includes a performance database 410, a production database 420, and an application programming interface 430. Performance database 410 may reside on a private server, and may be where data received from tracking system database 300 is stored. Performance database 410 can transmit data to production database 420, and/or can use more current data to update older data already in production database 420. Production database 420 may reside on a public server separated from production database 420 by a firewall, and may be configured to provide data to player device 500 via application programming interface 430.

Gameplay analysis device 400 can analyze gameplay data 810 to determine characteristics of each game machine 200. Such characteristics can be characteristics of each game machine 200 presently, and/or characteristics of each game machine 200 at any point or for any period in the past for which gameplay data 810 is available, and can be accounted for in the aggregate or grouped, for example, by game type, by denomination, or by individual player 600. Data representing such characteristics may be referred to as machine characteristic data 840, and is a type of result data 820. Such characteristics can include, for example, game type, denomination, value input (i.e., “coin in”), value output (i.e., “coin out”), actual hold, theoretical hold, number of jackpots over a period, average period between jackpots, period since last jackpot, jackpots paid in total, jackpot frequency, jackpot payout as a percentage of total payout, number of winning games over a period, average win amount per game played, average win amount per winning game, frequency of a winging game, games played since the last winning game, and popularity of a particular game machine 200 compared to other game machines 200 (based, for example, on game type and denomination). In some embodiments, machine characteristic data 840 includes data relating to the relative performance of different game machines 200 (e.g., the value of the average of a characteristic of one group of game machines 200 (which may include one or more game machines 200) as a function of or in direct comparison to the average of that characteristic for another group of game machines 200 (which may include one or more game machines 200); or a ranking or grouping of a plurality of game machines 200 according to the relative value(s) of one or more game machine characteristics).

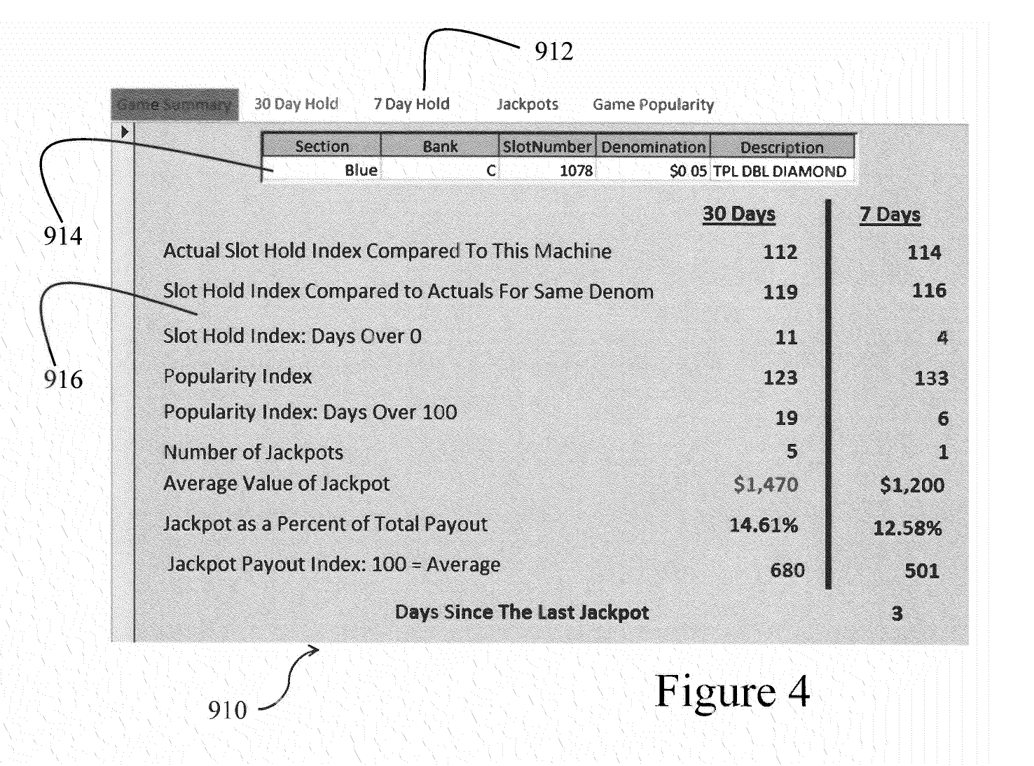

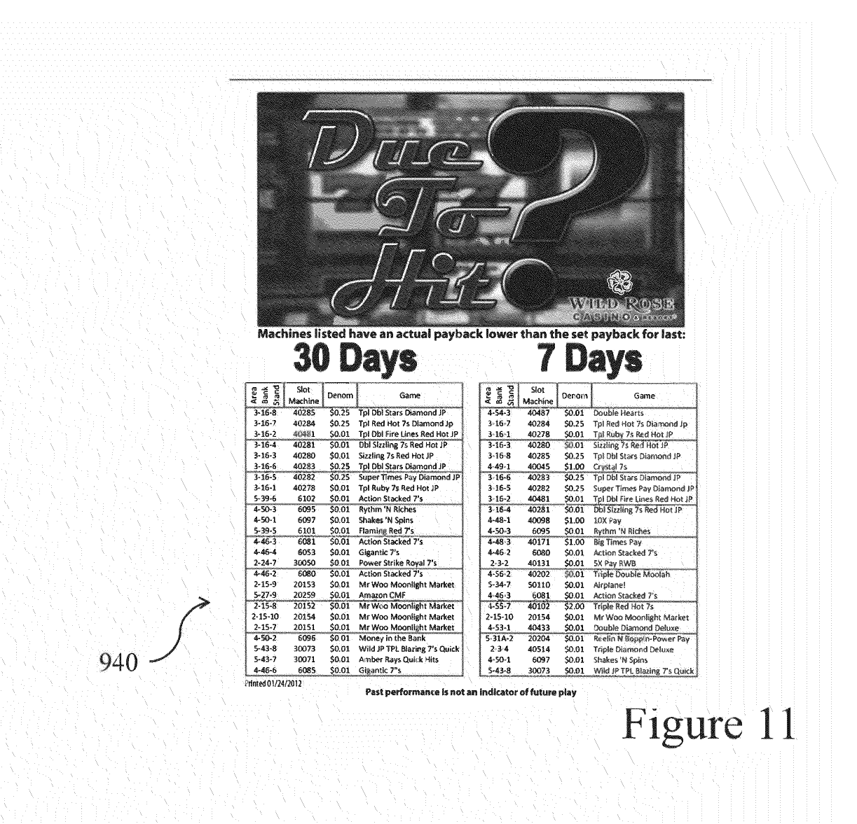

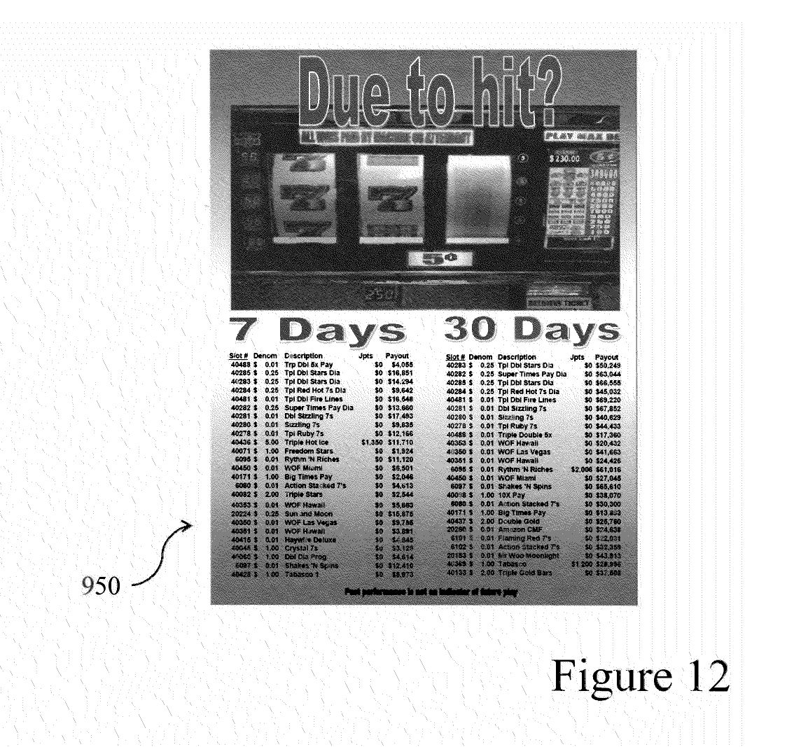

For example, in some embodiments, gameplay analysis device 400 can identify a variety of characteristics of one or more game machines 200, which can be displayed for observation by subject player 610 via player device 500. See, for example, FIGS. 4-14.

Gameplay analysis device 400 can analyze gameplay data 810 to determine characteristics of game machines 200 played by subject player 610. Gameplay analysis device 400 can identify subsets of game machines 200 at which subject player 610 obtained similar outcomes—for example, positive outcomes, negative outcomes, positive outcomes resulting in gain to subject player 610 of value above a threshold amount, negative outcomes resulting in loss to subject player 610 of value above a threshold amount, and/or other outcomes and/or subsets thereof. Gameplay analysis device 400 can identify characteristics common to game machines 200 (or a subset thereof) at which subject player 610 achieved similar outcomes. Data representing such characteristics may be referred to as personal characteristic data 850, and is a type of result data 820. In some embodiments, personal characteristic data can be replaced or supplemented by preference data 830, which can be input into game analysis system 100 by subject player 610 (e.g., via player device 500). Preference data 830 may represent characteristics of game machines 200 that subject player 610 has a preference for playing. In some embodiments, personal characteristic data 850 can be transmitted from gameplay analysis device 400 to player device 500, which may output a representation of such personal characteristic data 850.

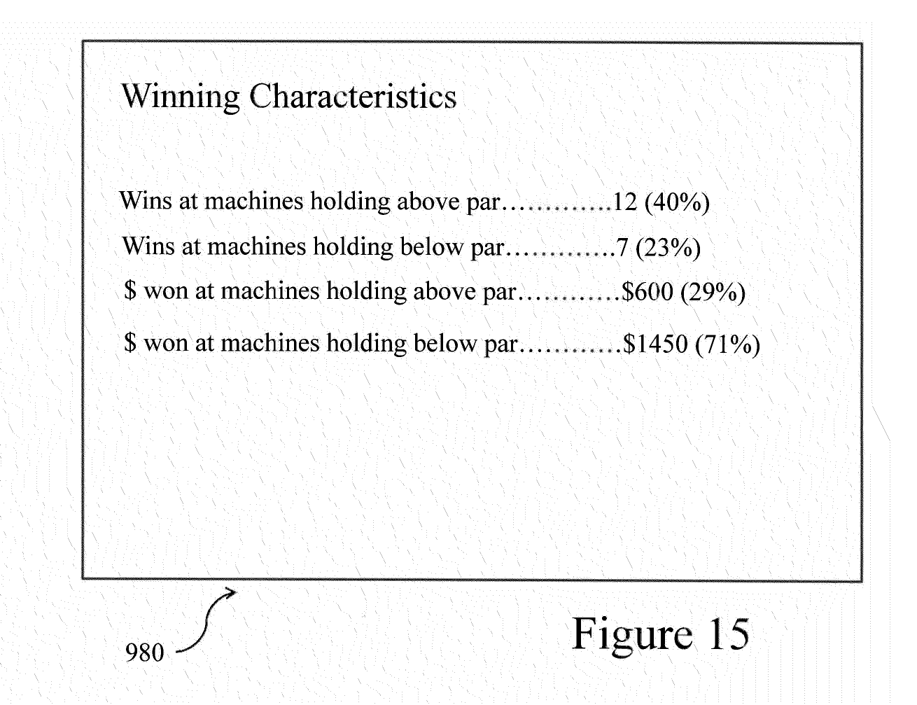

For example, in some embodiments, gameplay analysis device 400 can identify all or a subset of game machines 200 at which subject player 610 achieved a positive outcome over a period of time, can analyze the gameplay data 810 for each positive outcome game machine 200, can determine the characteristics of each positive outcome game machine 200 at the time the positive outcome(s) was achieved, and can identify characteristics common to the positive outcome game machines 200 at the time the positive outcome(s) was achieved. Such characteristics can be personal characteristic data 850, and can be displayed for observation by subject player 610 via player device 500. See, for example, FIG. 15.

Subject player 610 may be interested to know the characteristics common to game machines 200 at the time positive outcomes were achieved by subject player 610. Such knowledge may lead subject player 610 to seek out game machines 200 having these characteristics in the future, and may lead to subject player 610 playing such game machines 200 more often and/or wagering greater value at such game machines 200 than subject player 610 would have without such knowledge. In some embodiments, gameplay analysis device 400 transmits to player device 500 personal characteristic data 850 including information identifying characteristics common to the positive outcome game machines 200 at the time positive outcomes were achieved. In some embodiments player device 500 displays a representation of such personal characteristic data 850 on a display screen thereof (see, e.g., FIG. 15), thereby presenting it for observation by subject player 610. Subject player 610's possession of such information may influence subsequent wagering decisions of subject player 610.

In some embodiments, instead of or in addition to transmitting personal characteristic data 850 to player device 500, gameplay analysis device 400 may analyze gameplay data 810 to identify suggested game machines 210 that presently (according to the most current available gameplay data 810) have characteristics common to those of subject player 610's positive outcome game machines 200 at the time the positive outcomes were achieved, as represented by the personal characteristic data 850. Data identifying such suggested game machines 210 may be referred to as suggested machine identification data 860, and is a type of result data 820. In some embodiments, suggested machine identification data 860 can be transmitted from gameplay analysis device 400 to player device 500, which may output a representation of such suggested machine identification data 860.

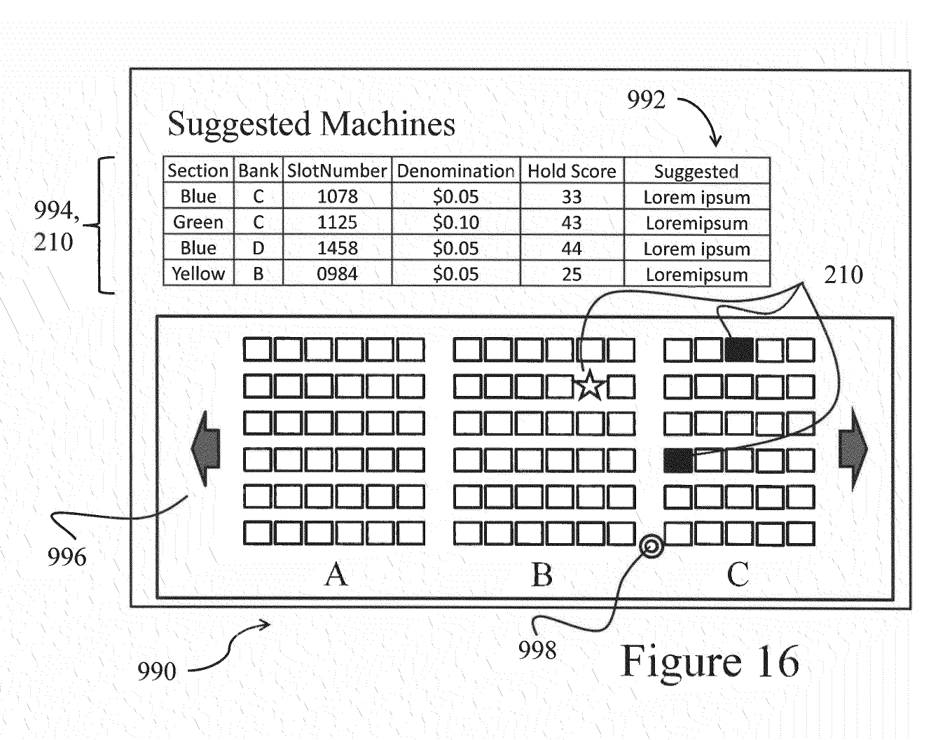

For example, in some embodiments gameplay analysis device 400 can identify one or more suggested game machines 210 by identifying commonalities among machine characteristic data 840 and personal characteristic data 850 for subject player 610's positive outcomes. In some embodiments gameplay analysis device 400 transmits to player device 500 suggested machine identification data 860 identifying the suggested game machines 210. In some embodiments player device 500 can display a representation of such suggested machine identification data 860, thereby identifying suggested game machines 210 to subject player 610. See, for example, FIG. 16. Subject player 610's possession of such information may influence subsequent wagering decisions of subject player 610.

A variety of reports can be output by game machine analysis device 400, and can be presented for observation by subject player 610. Such reports can be generated based on result data 820. In some embodiments, player device 500 receives result data 820 from gameplay analysis device 400. Result data 820 may include, for example, machine characteristic data 840, personal characteristic data 850, and/or suggested machine identification data 860. In some embodiments, player device 500 outputs a report of result data 820 (see, e.g., FIGS. 4-16). For example, player device 500 may include a display for displaying the report of result data 820 (e.g., a Liquid Crystal Display (LCD) display, a Light Emitting Diode (LED) display, an Organic Light Emitting Diode (OLED) display, a Cathode Ray Tube (CRT) display, and/or an ink/toner-and-paper printer), and/or an audio speaker for producing audio representations of result data 820.

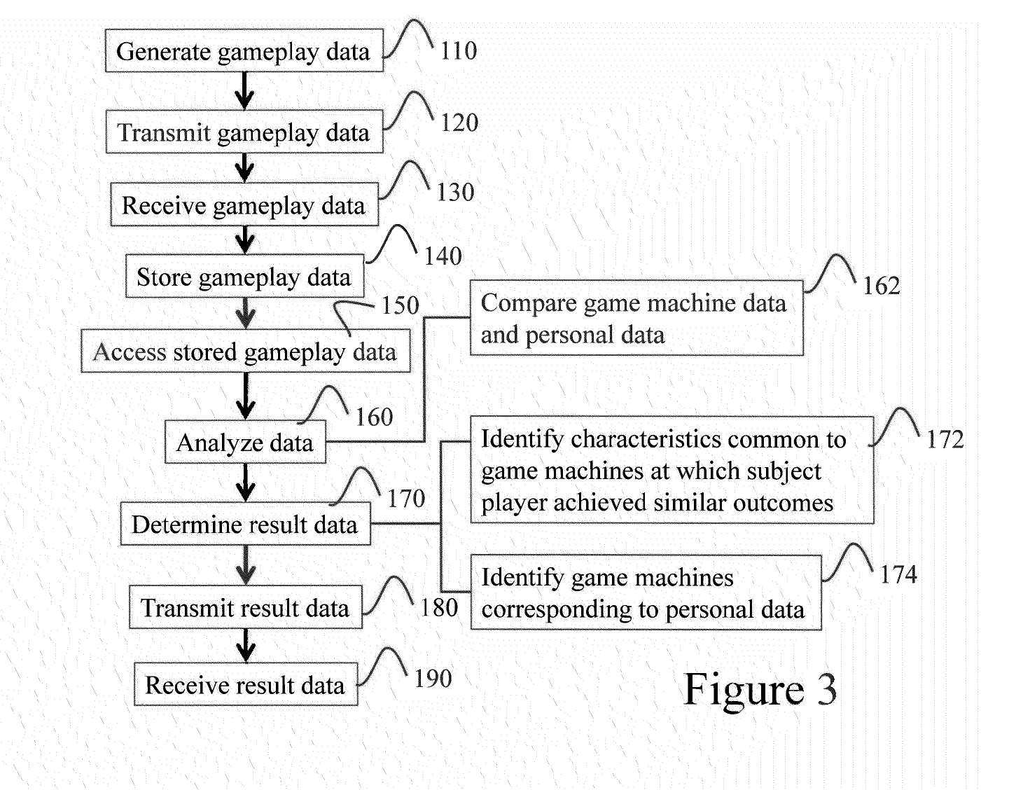

An exemplary method for analyzing a game using game analysis system 100 is depicted in FIG. 3. At operation 110, gameplay data 810 is generated. For example, game machines 200 may generate gameplay data 810. At operation 120, gameplay data 810 is transmitted. For example, game machines 200 may transmit gameplay data 810 to tracking system database 300. At operation 130, gameplay data 810 is received. For example, tracking system database 300 may receive gameplay data 810 from game machines 200. At operation 140 gameplay data 810 is stored. For example, tracking system database 300 may store gameplay data. At operation 150, gameplay data 810 is accessed. For example, gameplay analysis device 400 may access gameplay data 810. At operation 160, gameplay data is analyzed. For example, gameplay analysis device 400 may analyze gameplay data 810. At operation 162, game machine characteristic data 840 of gameplay data 810 is compared with personal characteristic data 850 of gameplay data 810. For example, gameplay analysis device 400 may perform this analysis.

At operation 170, result data 820 is determined. For example, gameplay analysis device 400 may determine result data 820. At operation 172, characteristics common to game machines 200 at which subject player 610 obtained similar outcomes are identified as personal characteristic data 850. For example, gameplay analysis device 400 may identify characteristics common to game machines 200 at which subject player 610 obtained positive outcomes. At operation 174, identification information of game machines 200 having machine characteristic data 840 having commonalities with the personal characteristic data 850 are identified as result data 820. For example, gameplay analysis device 400 may identify game machines 200 having machine characteristic data 840 having commonalities with machine characteristic data 840 of game machines 200 at which subject player 610 obtained positive outcomes.

At operation 180, result data 820 is transmitted. For example, gameplay analysis device 400 may transmit result data to player device 500. At operation 190, result data is received. For example, player device 500 may receive and display result data 820 from gameplay analysis device 400.

Exemplary reports are shown in FIGS. 4-16. The reports may represent data in an easy-to-understand way—for example, using text, graphics, tables, and/or graphs. The reports may represent data for a single game machine 200 (e.g., a game machine 200 queried by subject player 610, or a suggested game machine 210), or may represent more than one game machine 200 (e.g., multiple game machines 200 queried by subject player 610, or suggested game machines 210). Subject player 610 may query a game machine 200 in a variety of ways, including, for example, by selecting an option to do so presented at the game machine 200 or player device 500, or by scanning a game machine 200's QR code with a QR-enabled device (e.g., player device 500, in some embodiments).

In some embodiments, the reports may represent data, for example, game machine characteristic data 840, for a plurality of game machines 200 comparatively. For example, one or more characteristics of one or more game machines 200 can be represented relative to the same or similar characteristics of other game machines 200. In some embodiments, game machines 200 can be ranked according to one or more characteristics.

In some embodiments, a report outputted by player device 500 may represent the actual hold of the reported game machine(s) 200 for a period, which may be represented in comparison to the theoretical hold of the reported game machine(s) 200, to the average hold of all game machines 200 or a subset of all game machines 200 (e.g., the reported game machine(s) 200), or to a slot hold index (e.g., a measure of the degree to which a game machine 200 is holding above or below its theoretical hold). Also, in some embodiments, a report may represent the jackpot value, frequency, or total payout for a period. Also, in some embodiments, for example, a report may represent the popularity of the reported game machine(s) 200 compared to all or a subset of other game machines 200 for a period.

Also, in some embodiments, a report may represent the top 25 game machines 200 by hold score for a period (e.g., greatest hold above or below par for the past 7 and/or 30 days). Also, in some embodiments, a report may represent the hold score of all or a subset of game machines 200 for a period. Also, in some embodiments, a report may represent subject player 610's play results of one or more queries game machines 200 for a period. Also, in some embodiments, a report may represent characteristics of game machines 200 at which subject player 610 obtained positive outcomes for a period. Also, in some embodiments, a report may represent characteristics of suggested game machines 200 suggested by game analysis system 100 for play by subject player 610.

Also, in some embodiments, a report may represent the jackpot frequency for a period, including the average jackpot period (i.e., the average period between jackpots), the period since last jackpot, the next jackpot “due” date (i.e., the last jackpot date plus the average jackpot period), and the current number of days past the jackpot “due” date. In some embodiments, the jackpot “due” date and days past “due” may not be displayed to players 600, but may be used, for example, to rank game machines 200 displayed in a report.

Also, in some embodiments, a report may represent a hit frequency of a machine for a period (e.g., the number of games played divided by the number of games won for the period). Also, in some embodiments, a report may represent a hit frequency index that represents the hit frequency of a game machine 200 for one period relative to the hit frequency of that game machine 200 for another period. For example, the hit frequency index may provide a ratio of the hit frequency of a game machine 200 for the past 7 days and the hit frequency of that game machine 200 over the life of the game machine 200.

Also, in some embodiments, a report may represent the average payout per play for a period for one or more game machines 200 (e.g., the total payout for the period divided by the number of games played for the period). Also, in some embodiments, a report may represent the average payout per win for a period for one or more game machines 200 (e.g., the total payout for a period, divided by the number of wins during the period).

Such reports can present information pertaining to any period(s) for which data is available. In some embodiments, the period can be input by a user, selected by a user, preset, or automatically determined by game analysis system 100. For example, the period may be the current day, yesterday, the 7 days prior to yesterday, or the 30 days prior to yesterday.

FIGS. 4-8 show an exemplary report 910 for a queried game machine 200. Such a report may be generated based on result data 820, for example, machine characteristic data 840. In some embodiments, such a report can also be generated for a single game machine 200, or for more than one game machine 200. Exemplary report 910 includes tabs 912 allowing navigation among, types of information represented in exemplary report 910. The “game summary” tab is shown in FIG. 4, and shows a game machine identification bar 914, and a game machine performance section 916. Game machine identification bar 914 shows information identifying the location of the queried game machine 200, including its section (Blue) and bank (C). Game machine identification bar 914 also shows information identifying the queried game machine 200 by slot number (1078) and game description (TPL DBL DIAMOND). Game machine identification bar 914 also shows information identifying the value denomination accepted at the queried game machine 200 ($0.05).

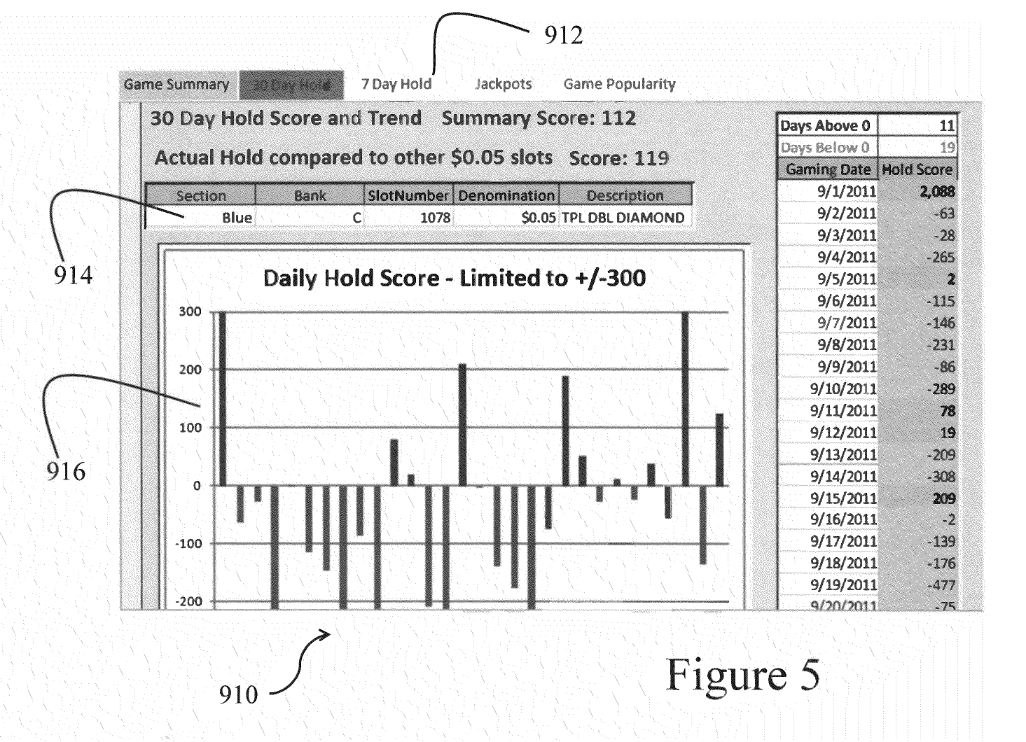

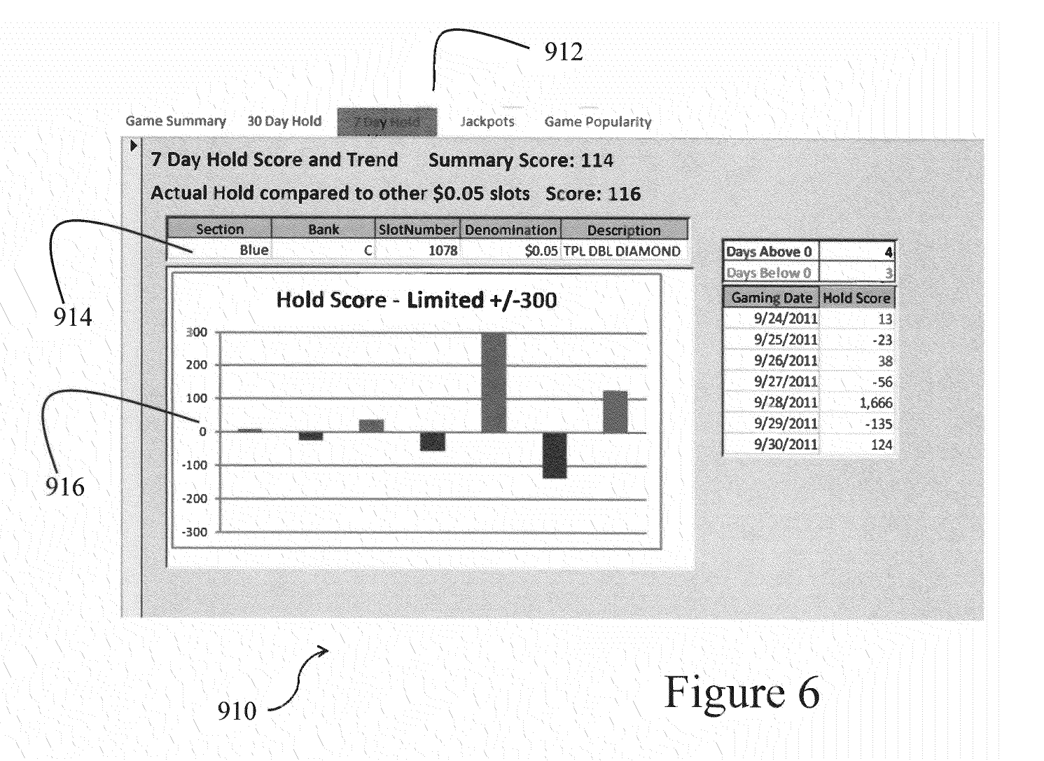

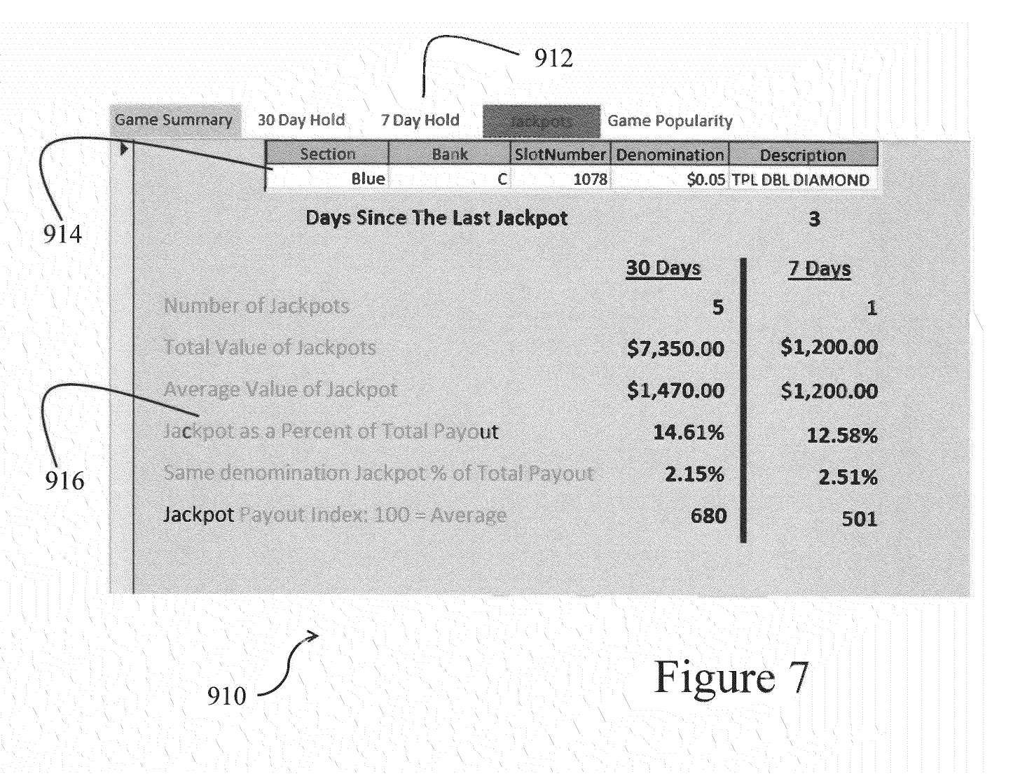

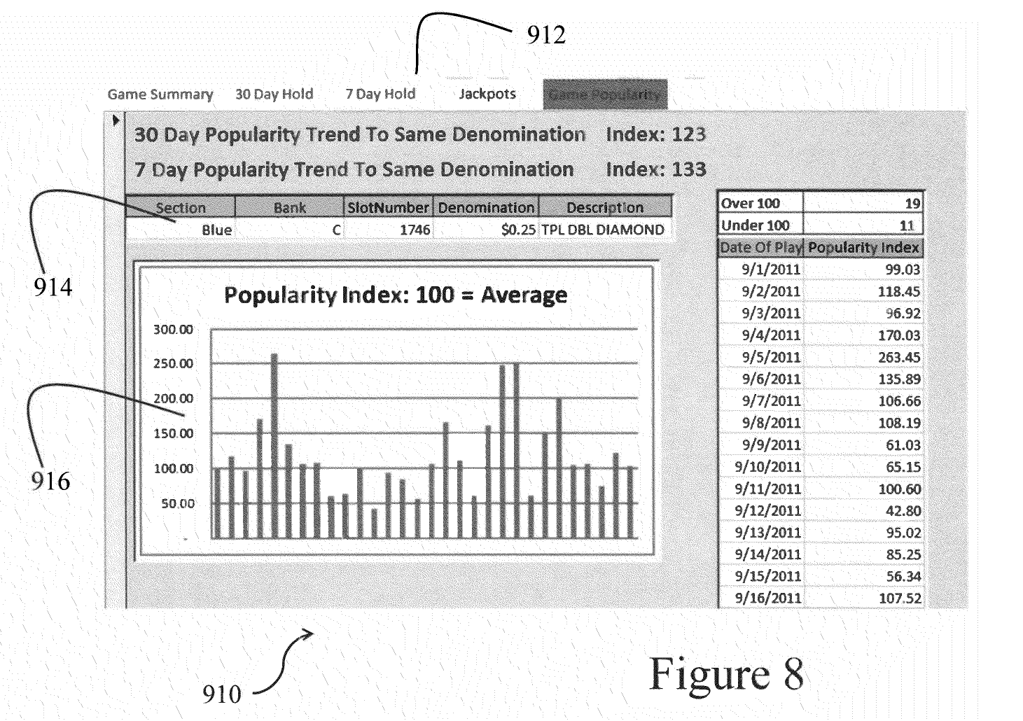

Game machine performance section 916 shows information about the performance of the queried game machine 200. In the depiction of exemplary report 910 shown in FIG. 4, game machine performance section 916 shows a summary of the performance of the queried game machine 200. In the depiction of exemplary report 910 shown in FIG. 5, showing the “30 Day Hold” tab, game machine performance section 916 shows detailed information about hold score over the past 30 days. The hold score is an indication of the actual hold of the queried game machine 200 compared to other game machines 200—in this case, other $0.05 slot machines. In the depiction of exemplary report 910 shown in FIG. 6, showing the “7 Day Hold” tab, game machine performance section 916 shows detailed information about hold score over the past 7 days. In the depiction of exemplary report 910 shown in FIG. 7, showing the “Jackpots” tab, game machine performance section 916 shows detailed information about jackpots at the queried game machine 200 over the past 7 days and 30 days, as well as the number of days since the last jackpot. In the depiction of exemplary report 910 shown in FIG. 8, showing the “Game Popularity” tab, game machine performance section 916 shows detailed information about the popularity of the queried game machine 200 over the past 7 days and 30 days.

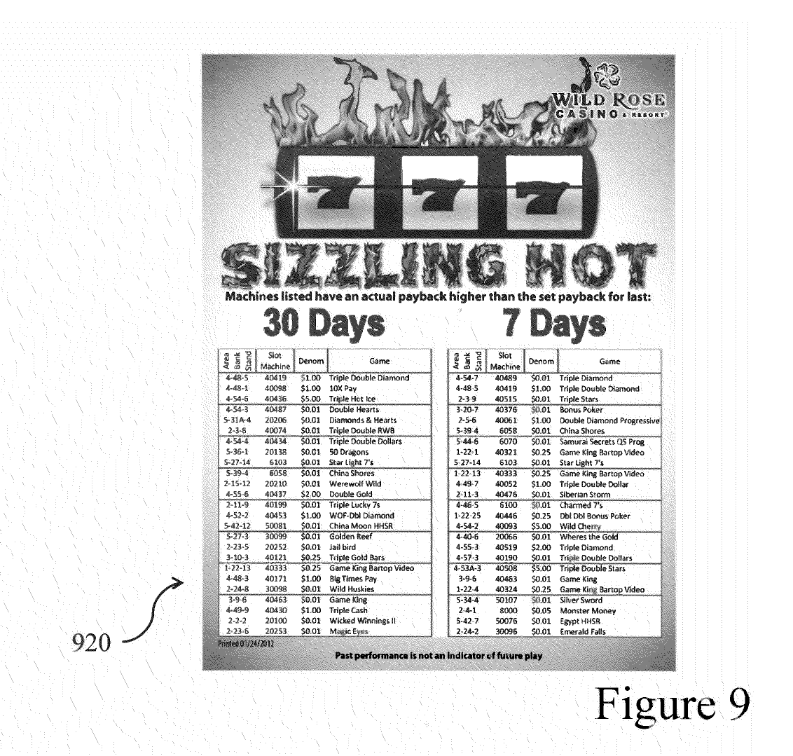

FIGS. 9-12 show exemplary reports 920, 930, 940, and 950 for game machines having characteristics meeting or exceeding a threshold or other criteria. Such reports may be generated based on result data 820, for example, machine characteristic data 840. Exemplary reports 920 and 930 identify game machines 200 having an actual payback of higher than their set payback (i.e., holding below par) for the past 30 days and for the past 7 days. Exemplary reports 940 and 950 identify game machines 200 having an actual payback of lower than their set payback (i.e., holding above par) for the past 30 days and for the past 7 days. In some embodiments, subject player 610 can select a representation of a particular game machine 200 to be provided with more detailed information about that game machine 200 (such as, for example, that shown in exemplary report 910 or 970).

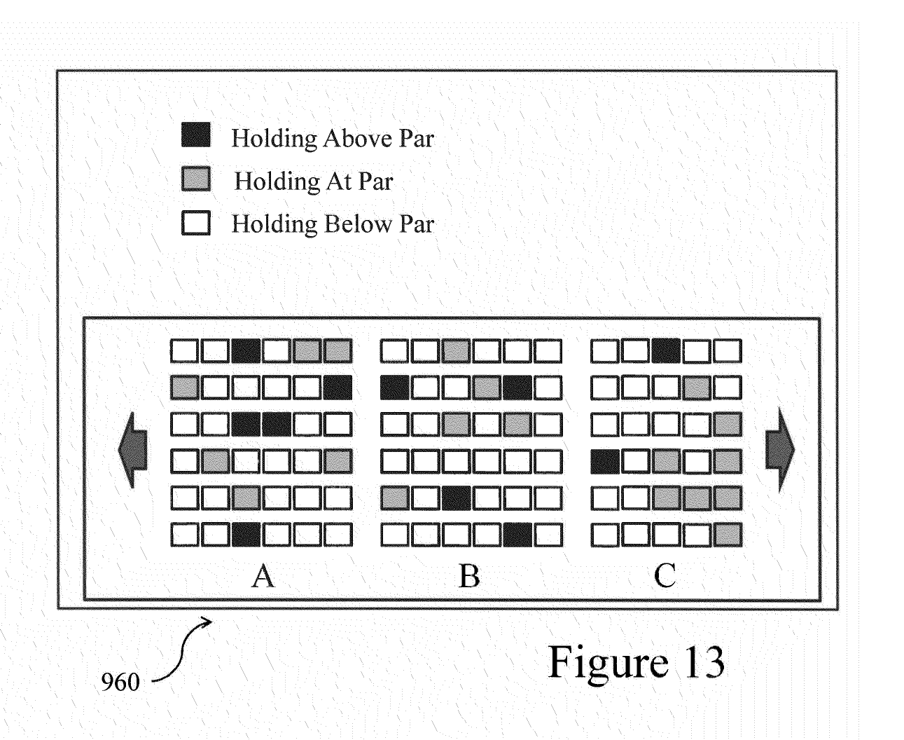

FIG. 13 shows an exemplary report 960 representing game machine characteristics relative to one or more thresholds or other criteria. Exemplary report 960 represents a color-coded map of game machines 200. Colors depicted at representations of game machines 200 can be indicative of one or more characteristics thereof. In exemplary report 960, the color of each game machine 200's representation corresponds to that game machine 200's hold relative to par. In some embodiments, subject player 610 can select a representation of a particular game machine 200 to be provided with more detailed information about that game machine 200 (such as, for example, that shown in exemplary detailed report 910 or 970).

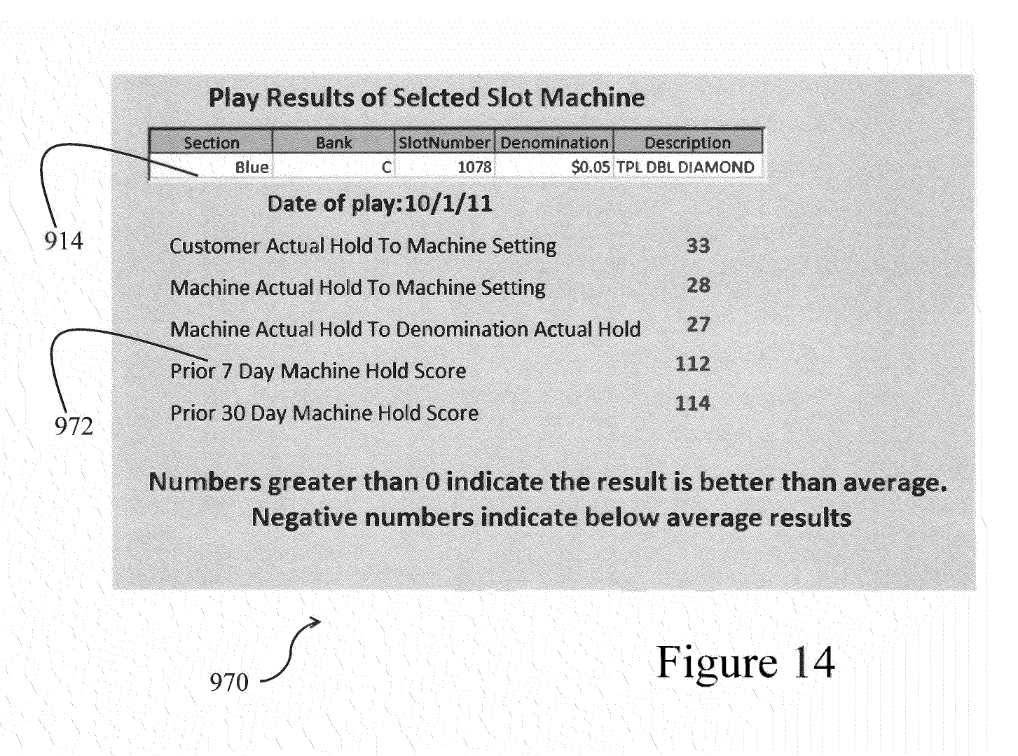

FIG. 14 shows an exemplary report 970 representing performance of a subject player 610 over the course of a day. Such a report may be generated based on result data 820, for example, machine characteristic data 840. Exemplary report 970 represents performance of subject player 610 at a queried game machine 200. In some embodiments, such a report can also represent performance of subject player 610 at more than one game machine 200, and over a period of time greater or less than one day. Exemplary report 970 includes a game machine identification bar 914, and a player performance section 972. Player performance section 972 shows information about the performance of subject player 610. In the depiction of exemplary report 970 shown in FIG. 14, player performance section 972 shows a summary of the performance of subject player 610 on a particular date as well as an indication of machine performance generally. Player performance section 972 shows an indication of player performance relative to actual and theoretical play on the queried machine 200.

FIG. 15 shows an exemplary report 980 identifying characteristics common to game machines 200 (or a subset thereof) at which subject player 610 achieved positive outcomes, at the time the positive outcomes were achieved. Such a report may be generated based on result data 820, for example, personal characteristic data 850. Exemplary report 980 represents the number and value of subject player 610's positive outcomes at game machines 200 grouped by hold with respect to par. As with other reports described herein, such a report is not limited to representations of the exemplary characteristics shown, (here hold with respect to par), but may be based on any other characteristic(s) of game machine(s) 200 and/or play by subject player 610.

FIG. 16 shows an exemplary report 990 identifying suggested game machines 210 that are suggested for play by subject player 610. Such a report may be generated based on result data 820, for example, suggested machine identification data 860. Exemplary report 990 may show suggestions based on a variety of criteria, and may provide an indication of such suggestion criteria 992.

In some exemplary embodiments, suggested game machines 210 suggested in exemplary report 990 are those game machines 200 presently (or according to the most current available data) having machine characteristic data 840 that includes at least one commonality with machine characteristic data 840 of game machines 200 played by subject player 610 at or just before the time of play by subject player 610.

In some exemplary embodiments, suggested game machines 210 suggested in exemplary report 990 are those game machines 200 presently (or according to the most current available data) having machine characteristic data 840 that includes at least one commonality with game machine characteristic data 840 of game machines 200 at which subject player 610 achieved a positive outcome, at or just before the time of play by subject player 610.

In some exemplary embodiments, suggested game machines 210 suggested in exemplary report 990 are those game machines 200 presently (or according to the most recently available data) having machine characteristic data 840 that includes at least one commonality with preference data 830 of subject player 610.

Commonalities may be based on any recorded or determined characteristic of game machines 200, including, for example, one or more of hold score, performance, denomination, game type, and any other characteristic as would be apparent to one of skill in the art, including those described herein. Commonalities need not be exactly matching values, but can be values within a defined range of each other.

Game machine suggestions may be represented in a report, such as, for example, exemplary report 990, in a variety of manners. For example, textual information 994 identifying location(s) and characteristic(s) of suggested game machines 210 can be provided. Alternatively or additionally, locations of suggested game machines 210 can be represented spatially—for example, on a map 996. For example, suggested game machines 210 can be represented in color(s) or shapes different from non-suggested game machines 200 (as also shown in the exemplary report 960 of FIG. 13). In some embodiments, subject player 610 can select a representation of a particular game machine 200 to be provided with more detailed information about that game machine 200 (such as, for example, that shown in exemplary report 910 or 970).

In some exemplary embodiments, the location 998 of subject player 610 can also be represented. The location of subject player 610 can be determined by, for example, a global positioning satellite (GPS) receiver in player device 500 (based on the assumption that subject player 610 is carrying player device 500).

Result data 820 can be provided (e.g., in the form of a report) to subject player 610 at any time. For example, representations of result data 820 can be provided to subject player 610 prior to playing a game machine 200. Also for example, representations of result data 820 can be provided to subject player 610 at the end of the day (e.g., an analysis of subject player 610's actual play compared to each played game machine 200's characteristics for the day and/or other periods, such as shown, for example, in exemplary report 970 in FIG. 14). Also for example, representations of result data 820 can be provided as an alert (e.g., a specific message or other notification) sent to and/or accessible via player device 500, to notify subject player 610 when characteristics of a game machine 200 sufficiently correspond (e.g., are within a defined range) to preferences of subject player 610 and/or characteristics of game machines 200 at which subject player 610 was previously successful. Alert parameters, such as data defining which characteristics must correspond to trigger an alert, the degree to which these characteristics must correspond to trigger an alert, as well as other data affecting triggering of an alert, can be stored in a database, such as, for example, tracking system database 300, performance database 410, or production database 420. Also for example, representations of result data 820 can be provided to subject player 610 upon entry to a gaming establishment (e.g., a list of the game machines 200 that most closely match preferences of subject player 610 and/or characteristics of game machines 200 at which subject player 610 was previously successful).

In some embodiments messages can be sent to subject player 610, and responses sent from subject player 610, via player device 500. Such messages can provide, for example, alerts (as described herein), and/or incentives for subject player 610 (e.g., to receive a discount at the gaming establishment's buffet, or to play one or more particular game machines 200 at a discounted rate). Such responses can provide an indication of acceptance or rejection of an offer, and can be sent by affirmative action of subject player 610 (e.g., via input into player device 500) or automatically in response to subject player 610 taking an action with respect to game analysis system 100 that shows acceptance of the offer (e.g., playing a particular game machine 200 at which a discount was offered, or entering an offer acceptance code from the offer message into an input of game machine 200). For example, where an alert has been provided to subject player 610 to notify subject player 610 that a game machine 200 corresponds to preferences of subject player 610 and/or characteristics of game machines 200 at which subject player 610 was previously successful, subject player 610 may be offered an enticement, such as, for example, an offer of free play on that game machine 200 if subject player 610 plays the machine within a specified period of time. Subject player 610 may be provided a code to enter at that game machine 200 to redeem the free play. Data representing such messages and responses can be stored in a database, such as, for example, tracking system database 300, performance database 410, or production database 420.

Result data 820 can be sent in any manner as would be appreciated by one of skill in the art. For example, result data 820 can be e-mailed to a player, sent via a text or media message, sent via an application interface of a computer or handheld device, or provided in the form of physical paper reports.

In some embodiments, representations of result data 820 are made available via an interface of game machine 200 or a kiosk at the gaming establishment (i.e., game machine 200 or the kiosk also functions as player device 500). In such an embodiment, subject player 610 may insert his or her player identification card into a card reader of game machine 200 or the kiosk, or otherwise identify his or her account to game machine 200 or the kiosk. Subject player 610 may then choose to play game machine 200 (if at a game machine 200) or to leave game machine 200 or the kiosk, at which point the representation of result data 820 may terminate.

Result data 820 can be available for access by subject player 610 at any time. For example, result data 820 can be stored in a database such as, for example, tracking system database 300, performance database 410, or production database 420, or otherwise hosted on a publicly- or privately-accessible database accessible via the Internet or an intranet. In some embodiments, such data can be accessible through a web page via a general-purpose web browser, which can present representations of such data via an associated output, such as, for example, a display. In some embodiments, such data can be accessible via a dedicated application (e.g., an application resident on player device 500), which can present representations of such data via an associated output, such as, for example, a display. In some embodiments, such data may be accessed by subject player 610's input of appropriate commands via, for example, an interface of a web browser or dedicated application, or via subject player's scan of a QR code affixed to a game machine 200. In some embodiments, if hosted on a privately-accessible database, subject player 610 can be required to establish an account to access the database, which may be operated by the gaming establishment.

Regardless of how result data 820 is accessed, in some embodiments subject player 610 may select an option to view a representation of result data 820 for one or more game machines 200. Subject player 610 may select further options to manipulate the representation of result data 820 to represent result data 820 desired by subject player 610. Representations of result data 820 can be manipulated by subject player 610 to show information of interest to subject player 610. For example, subject player 610 may have the option to search or filter representations of result data 820 based on criteria such as, for example, individual game machine 200 identification information, denomination, game type, game title, by characteristics or ranges of characteristics of game machines 200, or by outcomes obtained by subject player 610.

Each access of game analysis system 100 by subject player 610 can require information to be input or otherwise provided by or on behalf of subject player 610, such as, for example, player account number, telephone number, or player name. Each access of game analysis system 100 by subject player 610 can be recorded, along with related information such as, for example, subject player 610's player account number, date and time of access, and identification of game machines 200 queried.

In some exemplary embodiments, game machines 200 can display representations of result data 820 during periods when not being played by a player 600, or after a period of time of not being played by a player 600.

Player device 500 can be a variety of devices, for example, a personal computer or laptop; a cellular phone, smartphone, or PDA; an interface on a game machine 200 or a kiosk; or a dedicated game machine analysis device. In this way, a subject player 610 may have multiple avenues to access game analysis system 100. Game analysis system 100 can determine and store access data representing each instance of access to game analysis system 100. This access data can include device identification information (e.g., identifying the type of device used to access game analysis system 100), access location information (e.g., information, such as an internet protocol address or global positioning system coordinates, identifying the location from which game analysis system 100 was accessed), and access record information (e.g., information identifying the content accessed by subject player 610). This access data can be stored in a database, such as, for example, tracking system database 300, performance database 410, or production database 420.

In some exemplary embodiments, player device 500 may be a dedicated game machine analysis device, including, for example, a QR reader and a display. The dedicated device may be loaned out by a gaming establishment to subject players 610 for use while at the gaming establishment. The dedicated game machine analysis device may have the ability to scan a QR code and receive a web page via a wireless network in response. The wireless network may be constrained to only allow communication between the dedicated device and gameplay analysis device 400. The dedicated device may be constrained so as to only operate on a particular wireless network of the gaming establishment. In some embodiments, the dedicated device may not have an external on/off switch. In such a case, the dedicated device can transition to an off mode when docked with a corresponding battery charger, and in an on mode when not docked with the charger. This would encourage its return to the gaming establishment by limiting its battery life outside the gaming establishment. In some embodiments the dedicated device can include a passive radio-frequency tag for inventory management and/or to trigger an alarm if passed through a radio-frequency reader at entry points of the gaming establishment. In some exemplary embodiments the dedicated device can include paging capabilities to enable a page or other message to be sent to the dedicated device (e.g., over the wireless network) by the gaming establishment. Such a page may be sent after a period of time has elapsed since subject player 610's last play of a game machine 200 or last use of game analysis system 100. In some exemplary embodiments the dedicated device can include a GPS chip that can be used, for example to track the dedicated device and/or to trigger an alarm when dedicated device is transported outside a defined area.

Transmission of data as described herein can occur in a variety of ways including according to a variety of protocols. Transmission of data between and among elements of game analysis system 100 need not take the same form. Different types of elements within game analysis system 100 can transfer data in different ways or in the same way. Different elements of the same type within game analysis system 100 can transfer data in different ways or in the same way. Elements of game analysis system 100 can transfer different data and/or different types of data in different ways. Elements of game analysis system 100 can transfer data in different ways at different times. Elements of game analysis system 100 can send data in ways different from the ways they receive data.

For example, transmission of data as described herein can occur via wired or wireless connections, and via a network such as, for example, an intranet or the Internet. Data may be transferred encrypted or non-encrypted.

The foregoing description of the exemplary embodiments of the invention will so fully reveal the general nature of the invention that others can, by applying knowledge within the skill of the art, readily modify and/or adapt for various applications such specific embodiments, without undue experimentation, without departing from the general concept of the present invention. For example, game analysis system 100 may analyze the play choices of a subject player 610 and may assign a player type to subject player 610. Player types may be developed to group players that appear to have similar play habits. Game analysis system 100 may be customized to present different information to different player types. For example, subject player 610 may be identified as a “progressive” player, which can indicate that he or she prefers to play progressive slot machines. In such a case, upon entry to the gaming establishment, subject player 610 may access game analysis system 100 and be presented with a list showing the locations of all progressive slot machines. Subject player 610 may also be presented with the option to view the progressive jackpot value when it was hit for the last year (or other period of time). Subject player 610 may also be presented with the option to view which progressive slot machines have hit the progressive, the dates of the hits, and the jackpot payout. Subject player 610 may also be presented with the option to create an alert to notify subject player 610 when the progressive is at a percentage of the alert value (e.g., 95%, 100%, and/or 105%). Subject player 610 may also be notified anytime the progressive is hit (e.g., via e-mail, text (SMS) message). In some embodiments, such a player alert may be accompanied by an offer of free credit play to subject player 610, provided subject player 610 plays a designated game machine 200 within a specified time period.

In a similar way, the information presented to or accessible by a subject player 610 can be tailored to any other defined “type” of player. In some embodiments, a subject player may choose his or her own player type, in order to receive such a customized information presentation.

Also, for example, game analysis system 100 has been described in terms of conceptual components, for ease of description. These components may be combined or further separated without departing from the spirit and scope of the invention. For example, tracking system database 300 and gameplay analysis device 400 can be combined. Also for example, game machines 200 and tracking system database 300 can be combined. Also for example, game machines 200, tracking system database 300, and gameplay analysis device 400 can be combined. Also for example, tracking system database 300, gameplay analysis device 400, and player device 500 can be combined. Also for example, game machines 200, tracking system database 300, gameplay analysis device 400, and player device 500 can be combined.

Also for example, in some embodiments the analysis functions of gameplay analysis device 400 are performed by player device 500.

Also for example, in some embodiments player device 500 receives result data 820 via an intermediate database, instead of or in addition to receiving result data 820 directly from gameplay analysis device 400. For example, in such an embodiment, gameplay analysis device 400 may transmit result data 820 to the intermediate database, and player device 500 can access result data 820 from the intermediate database. Such intermediate database can be any suitable database, including those described herein, for example, tracking system database 300. Such intermediate database may be accessible to player device 500 via a network such as, for example, the Internet or an intranet.

Also for example, in some embodiments subject player 610 may access result data 820 and/or related features or data using an application interface of player device 500. The application interface may be provided, for example, by a software program (also known as an “application” or an “app”) residing on player device 500 that can access result data 820 (e.g., via application programming interface 430). The app can be downloadable to player device 500 to provide player device 500 with the capabilities described herein. The app may allow or require subject player 610 to input identification information (e.g., name, player account number, date of birth) via the application interface in order to access the capabilities of the app. Identification information of player device 500 (e.g., a device identification number, internet protocol address, or serial number) may also be obtained by the app. The app may transmit the identification information to a server to verify the player account and device.

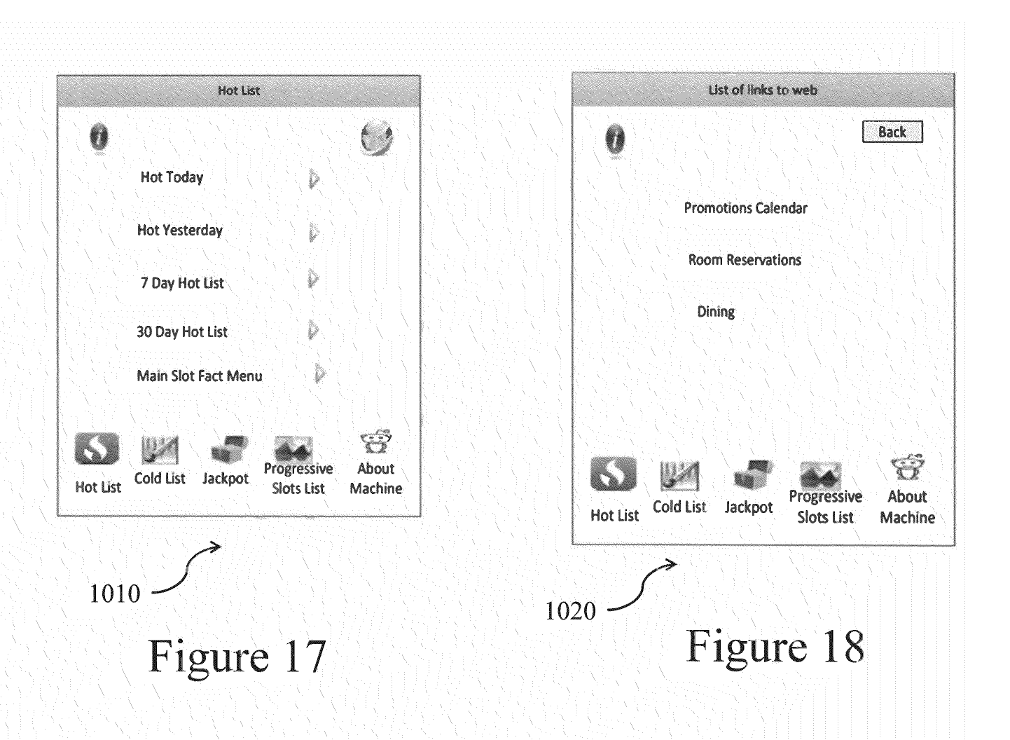

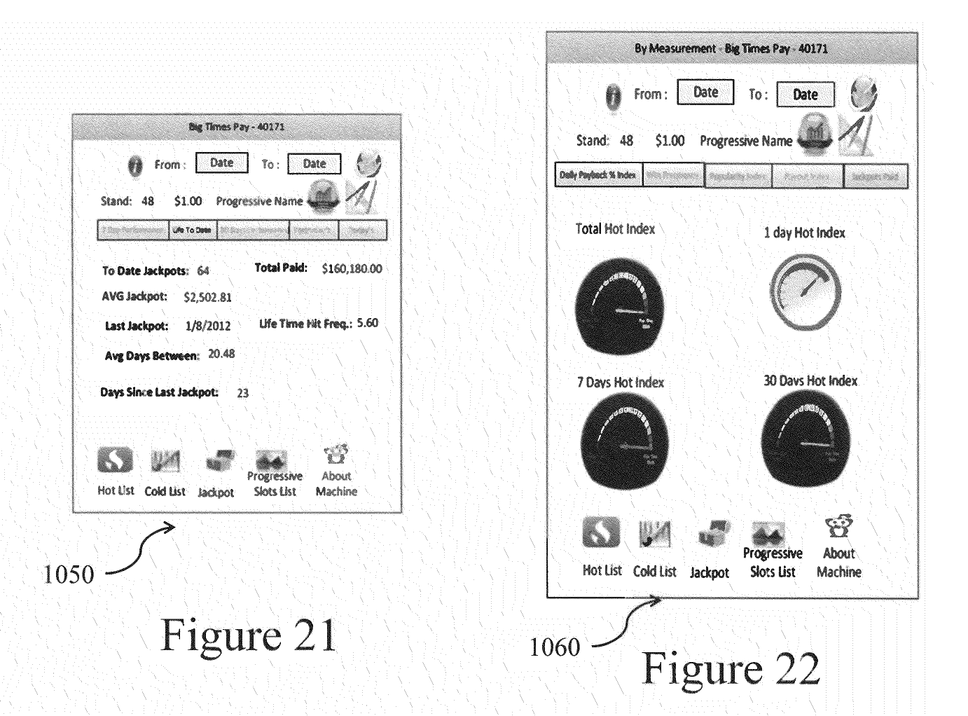

The app may provide result data 820 and other information in any manner as described herein or as would be apparent to one of skill in the art, including by the presentation of reports such as, for example, the exemplary reports described herein. Also, any presentation of data and/or reports described herein with reference to the app can be effected via any other form of player device 500 described herein or as would be apparent to one of skill in the art. FIGS. 17-22 provide exemplary reports 1010, 1020, 1030, 1040, 1050, and 1060, which can be displayed via the application interface and/or navigated among by manipulating inputs of player device 500.

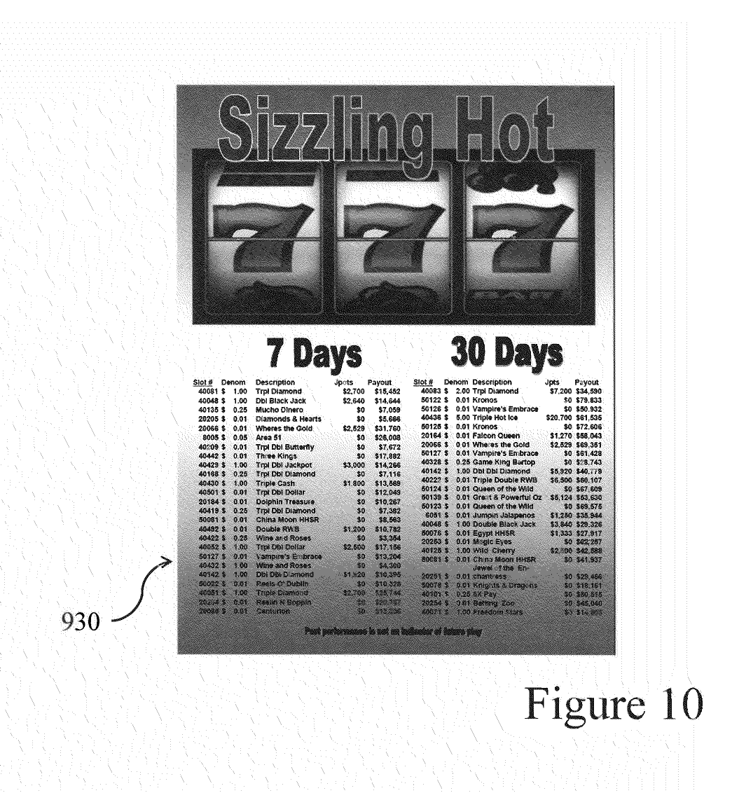

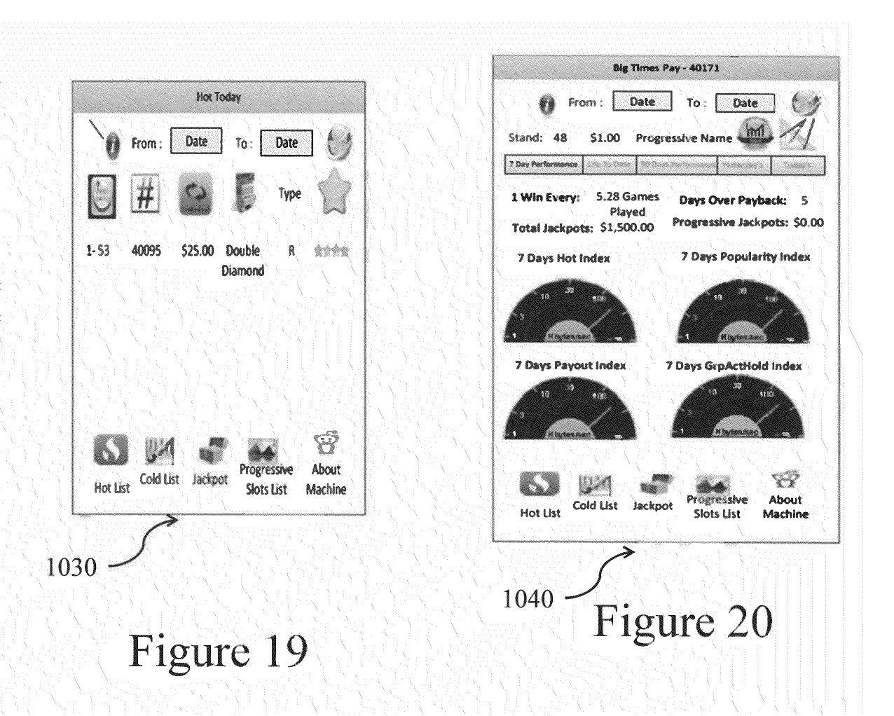

Exemplary report 1010 provides a menu allowing subject player 610 to select display of game machines 200 according to characteristics thereof. Specifically, exemplary report 1010 allows selection of game machines 200 that are hot (i.e., holding below par) on the present day (see, e.g., exemplary report 1030 in FIG. 19), that were hot yesterday, that have been hot for the past 7 days (see, e.g., exemplary reports 920 and 930 in FIGS. 9 and 10), or that have been hot for the past 30 days (see, e.g., exemplary reports 920 and 930 in FIGS. 9 and 10). Exemplary report 1010 also provides an option to view game machine facts (see, e.g., exemplary reports 1040 and 1050). Exemplary report 1010 also provides an option to view other information about the gaming establishment, by providing access to links to, for example, a promotions calendar, room reservations, and dining information (see, e.g., exemplary report 1020 in FIG. 18). Exemplary reports 1040, 1050, and 1060 provide information about the performance of a selected game machine 200, including machine characteristic data 840 thereof.

Also, for example, in some embodiments game analysis system 100 may include displays that are not associated with or controlled by a particular subject player 610, and are not incorporated in player device 500. For example, gaming establishments may include LCD display screens positioned throughout the gaming establishment to provide information to viewers. These display screens may receive and output representations of result data 820 including, for example, reports (e.g., any of the reports described herein). The display screens may display a variety of different reports (e.g., sequentially).

In some embodiments, the display screens may display information unrelated to game analysis system 100 (e.g., as with a general-purpose television configured to display typical television programming). In such embodiments, representations of result data 820 may be displayed in conjunction with the display of this other data (e.g., by scrolling representations of result data 820 along the bottom of the display screen).

Also for example, in some embodiments, result data 820 can be represented by a series of light emitting diodes (LEDs) integrated into a game machine 200. Such LEDs may be arranged in a line or other arrangement such that the LEDs that are illuminated indicate machine characteristic data 840 of the game machine 200. For example, seven LEDs may be arranged on the face of a game machine 200. Illumination of the center LED may represent that the game machine 200 is holding at par. Illumination of one or more LEDs to one side of the center LED may represent that the game machine 200 is holding above par (with a higher number of illuminated LEDs representing greater hold above par). Illumination of one or more LEDs to the other side of the center LED may represent that the game machine 200 is holding below par (with a higher number of illuminated LEDs representing greater hold below par). The LEDs may be color coded (or may change color dynamically) to represent the extent to which the game machine 200 is holding above or below par. More than one line of LEDs may be included on a game machine 200. For example, one line of LEDs may represent the game machine 200's hold index for the current day, and a second line of LEDs may represent the game machine 200's hold index for the past 7 days.

While various embodiments of the present invention have been described above, they have been presented by way of example only, and not limitation. It should be apparent that adaptations and modifications are intended to be within the meaning and range of equivalents of the disclosed embodiments, based on the teaching and guidance presented herein. It therefore will be apparent to one skilled in the art that various changes in form and detail can be made to the embodiments disclosed herein without departing from the spirit and scope of the present invention. The elements of the embodiments presented above are not necessarily mutually exclusive, but may be interchanged to meet various needs as would be appreciated by one of skill in the art.

Various aspects of the present invention, or any parts or functions thereof, may be implemented using hardware, software, firmware, tangible computer readable or computer usable storage media having instructions stored thereon, or a combination thereof and may be implemented in one or more computer systems or other processing systems.

The systems and methods provided herein, and related computer program products can include any software application executed by one or more computing devices. A computing device can be any type of computing device having one or more processors. For example, a computing device can be a workstation, mobile device (e.g., a mobile phone, personal digital assistant, tablet computer, or laptop), computer, server, computer cluster, server farm, game console, set-top box, kiosk, embedded system or other device having at least one processor and memory. Embodiments of the present invention may be software executed by a processor, firmware, hardware or any combination thereof in a computing device.

In this document, “computer-usable medium” may be used to generally refer to media such as a removable storage unit or a hard disk installed in a hard disk drive. Computer-usable medium may also refer to memories, such as a main memory or a secondary memory, which can be memory semiconductors (e.g., DRAMs, etc.). These computer program products provide software to computer systems of the present invention.

Computer programs (also called computer control logic) may be stored on main memory and/or secondary memory. Computer programs may also be received via a communications interface. Such computer programs, when executed, may enable computer systems of the present invention to implement embodiments described herein. Where embodiments are implemented using software, the software can be stored on a computer program product and loaded into a computer system using, for example, a removable storage drive, an interface, a hard drive, and/or communications interface.

Based on the description herein, a person skilled in the relevant art will recognize that the computer programs, when executed, can enable one or more processors to implement processes described above, such as the steps in the methods illustrated by the figures. In an embodiment, the one or more processors can be part of a computing device incorporated in a clustered computing environment or server farm. Further, in an embodiment, the computing process performed by the clustered computing environment may be carried out across multiple processors located at the same or different locations.

Software of the present invention may be stored on any computer-usable medium. Such software, when executed in one or more data processing device, causes the data processing device to operate as described herein. Embodiments of the invention employ any computer-usable medium, known now or in the future. Examples of computer-usable mediums include, but are not limited to, primary storage devices (e.g., any type of random access or read only memory), secondary storage devices (e.g., hard drives, floppy disks, CD ROMS, ZIP disks, tapes, magnetic storage devices, optical storage devices, MEMS, nanotechnological storage devices, memory cards or other removable storage devices, etc.), and communication mediums (e.g., wired and wireless communications networks, local area networks, wide area networks, intranets, etc.).

Embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

It is to be understood that the phraseology or terminology used herein is for the purpose of description and not of limitation. The breadth and scope of the present invention should not be limited by any of the above-described exemplary embodiments, but should be defined only in accordance with the following claims and their equivalents.

1. A system for analyzing games of chance, the system comprising:
a database configured to receive and store gameplay data; and
a gameplay analysis device configured to perform analysis of the gameplay data and to output result data to a player device,
wherein the analysis comprises a comparison of machine characteristic data associated with a game machine with personal characteristic data associated with a subject player,
wherein the result data is based on the comparison of the machine characteristic data with the personal characteristic data, and
wherein the personal characteristic data is determined by analysis of play of one or more game machines by the subject player.

2. (canceled)

3. (canceled)

4. (canceled)

5. The system of claim 1, wherein the result data includes data identifying a suggested game machine for the subject player, and
wherein the suggested game machine has machine characteristic data that includes at least one commonality with machine characteristic data of a game machine at which the subject player obtained a positive outcome, at the time the positive outcome was obtained.

6. The system of claim 1, wherein the result data includes data identifying a suggested game machine for the subject player, and
wherein the suggested game machine has machine characteristic data that includes at least one commonality with machine characteristic data of a past game machine played by the subject player, immediately preceding the time of the past play.

7. The system of claim 1, wherein the result data includes data identifying a suggested game machine for the subject player, and
wherein the suggested game machine has machine characteristic data that includes at least one commonality with preference data of the subject player.

8. The system of claim 1, wherein the result data includes data identifying a suggested game machine for the subject player, and
wherein the result data is transmitted to the player device in response to a determination by the gameplay analysis device that the suggested game machine has machine characteristic data that corresponds to target machine characteristic data, and
wherein the target machine characteristic data is based on personal characteristic data of the subject player.

9. (canceled)

10. The system of claim 1, wherein the machine characteristic data is associated with a plurality of game machines.

11. The system of claim 10, wherein the game machine characteristic data includes data relating to the performance of one group of game machines compared to the performance of another group of game machines.

12. The system of claim 10, wherein the game machine characteristic data includes data relating to a ranking of game machines according to a game machine characteristic.

13. (canceled)

14. (canceled)

15. The system of claim 1, wherein the personal characteristic data comprises data relating to a characteristic common to game machines at which the subject player achieved positive outcomes.

16. The system of claim 1, further comprising the game machine,
wherein the game machine is configured to generate and transmit gameplay data, and
wherein the database is configured to receive the gameplay data from the game machine.

17. The system of claim 16, further comprising a plurality of game machines, wherein each game machine is configured to generate and transmit gameplay data, and
wherein the database is configured to receive the gameplay data from the plurality of game machines.

18. The system of claim 1, further comprising the player device, wherein the player device is configured to receive the result data and display a representation of the result data.

19. The system of claim 18, wherein the result data includes data identifying a suggested game machine, and
wherein the representation comprises a suggestion report including a representation of the suggested game machine.

20. The system of claim 19, wherein the representation further comprises a detailed report of the suggested game machine, and
wherein the detailed report is displayed in response to selection of the representation of the suggested game machine in the suggestion report.

21. The system of claim 1, wherein the gameplay data includes data relating to at least one of game type, denomination, coin in, coin out, actual hold, theoretical hold, jackpots paid in total, jackpot frequency, jackpot payout as a percentage of total payout, and popularity of a game machine compared to other game machines based on game type and denomination.

22. A method for analyzing games of chance, the method comprising:
receiving gameplay data at a database;
storing the gameplay data at the database;
accessing the gameplay data by a gameplay analysis device;
performing analysis of the gameplay data at the gameplay analysis device;
outputting result data from the gameplay analysis device,
wherein the analysis comprises comparing machine characteristic data associated with a game machine and personal characteristic data associated with a subject player,
wherein the result data is based on the comparison of the machine characteristic data and the personal characteristic data, and
wherein the personal characteristic data is determined analyzing play of one or more game machines by the subject player.

23. A tangible computer program product for analyzing games of chance, the product comprising a computer-usable medium having non-transitory computer program logic recorded thereon for causing at least one processor to:
receive gameplay data at a database;
store the gameplay data at a database;
access the gameplay data by a gameplay analysis device;
perform analysis of the gameplay data at the gameplay analysis device; and
output result data from the gameplay analysis device,
wherein the analysis comprises causing the at least one processor to compare machine characteristic data associated with a game machine and personal characteristic data associated with a subject player,
wherein the result data is based on the comparison of the machine characteristic data and the personal characteristic data, and
wherein the personal characteristic data is determined by causing the at least one processor to analyze play of one or more game machines by the subject player.

24. The system of claim 16, further comprising a quick response (QR) code coupled to the game machine,
wherein the gameplay analysis device is configured to output the result data in response to scanning the QR code.

25. The system of claim 24, wherein the result data is represented on a display of the gameplay analysis device, and
wherein the representation can be manipulated by the subject player to display selected game machine characteristics.

26. The system of claim 8, wherein the result data is output to the player device via an e-mail or text message.

27. The system of claim 1, wherein the result data is represented on a display of the gameplay analysis device as a slot hold index.

28. The system of claim 26, wherein the e-mail or text message comprises a time-limited incentive offered to the subject player based on previous play of the subject player.

29. The system of claim 1, wherein the result data includes data identifying a suggested game machine for the subject player, and wherein the suggested game machine has a progressive jackpot value within a determined percentage of an alert value associated with the subject player.
